(19) United States
(12) Patent Application Publication
(10) Pub. No.: US 2021/0129841 A1
(43) Pub. Date: May 6, 2021

(54) DRIVING ASSISTANCE DEVICE

(71) Applicant: TOYOTA JIDOSHA KABUSHIKI KAISHA, Toyota-shi (JP)

(72) Inventors: Yuta IKEZAWA, Susono-shi (JP); Kohei Tochigi, Sunto-gun (JP); Shogo Ito, Sunto-gun (JP)

(73) Assignee: TOYOTA JIDOSHA KABUSHIKI KAISHA, Toyota-shi (JP)

(21) Appl. No.: 16/990,405

(22) Filed: Aug. 11, 2020

(30) Foreign Application Priority Data
Nov. 5, 2019 (JP) 2019-200607

(51) Int. Cl. B60W 30/14; B60W 40/02; B60W 50/14; G08G 1/07; G08G 1/056

(52) U.S. Cl. CPC B60W 30/143; B60W 40/02; B60W 50/14; G08G 1/07; B60W 30/18154; B60W 2554/80; B60W 2555/60; B60W 2050/146; G08G 1/056

(57) ABSTRACT

A driving assistance device that assists in driving a vehicle that travels toward a traffic light with an arrow signal includes a recognizing unit that recognizes lighting of the arrow signal and a travelable direction, based on a detection result of an external sensor for sensing an external environment of the vehicle, and an assisting unit that performs first assistance including at least one of speed-reduction assistance for reducing the vehicle speed and informing assistance for prompting speed reduction of the vehicle, when the recognized travelable direction of the arrow signal is different from an expected traveling direction of the vehicle. When lighting of the arrow signal is recognized by the recognizing unit, and the travelable direction of the arrow signal is not recognized by the recognizing unit, the assisting unit performs second assistance having a smaller degree of assistance than the first assistance, until the travelable direction is recognized.

### INCORPORATION BY REFERENCE

The disclosure of Japanese Patent Application No. 2019-200607 filed on Nov. 5, 2019 including the specification, drawings and abstract is incorporated herein by reference in its entirety.

### BACKGROUND

### 1. Technical Field

The disclosure relates to a driving assistance device.

### 2. Description of Related Art

A system that performs driving assistance based on a result of recognition of a traffic light operable to light an arrow signal is disclosed in Japanese Unexamined Patent Application Publication No. 2019-016000 (JP 2019-016000 A). This system performs driving assistance when the direction of the arrow signal does not match the traveling direction of the vehicle when they are compared with each other. The driving assistance is control for seeking attention. This system performs speed reduction control, when the vehicle keeps traveling to enter an intersection even under the attention-seeking control.

### SUMMARY

In the meantime, when the arrow signal is seen from a distance, the shape of the arrow signal (or the direction indicated by the arrow signal) may not be recognized even if lighting of the arrow signal can be recognized. Thus, the system described in JP 2019-016000 A recognizes the direction of the arrow signal, at a position that is closer to the traffic light than a position at which lighting of the arrow signal can be recognized, and starts the driving assistance. Therefore, a vehicle occupant who has recognized lighting of the arrow signal may sense a delay in the start of the assistance.

To solve the above problem, it may be considered to perform driving assistance based on lighting of the arrow signal. However, the driving assistance system would start the driving assistance while the direction of the arrow signal is still uncertain. Thus, the driving assistance based on lighting of the arrow signal may turn out to be unnecessary assistance in the end. When the unnecessary assistance takes place often, the occupant may feel bothered.

This disclosure provide a driving assistance device that performs driving assistance based on a result of recognition of a traffic light operable to light an arrow signal, which can make the start of assistance earlier, and make a vehicle occupant less likely to be bothered.

One aspect of the disclosure is concerned with a driving assistance device that assists in driving a vehicle that travels toward a traffic light operable to light an arrow signal indicating a travelable direction. The driving assistance device includes a recognizing unit and an assisting unit. The recognizing unit is configured to recognize lighting of the arrow signal and the travelable direction, based on a detection result of an external sensor that detects information on an external environment of the vehicle. The assisting unit is configured to perform first assistance including at least one of speed-reduction assistance for reducing a speed of the vehicle and informing assistance for prompting speed reduction of the vehicle, when the travelable direction of the arrow signal of which lighting is recognized by the recognizing unit is different from an expected traveling direction of the vehicle. When lighting of the arrow signal is recognized by the recognizing unit, and the travelable direction of the arrow signal is not recognized by the recognizing unit, the assisting unit is configured to perform second assistance having a smaller degree of assistance than the first assistance, until the travelable direction of the arrow signal is recognized by the recognizing unit.

With the driving assistance device configured as described above, when lighting of the arrow signal is recognized by the recognizing unit, and the travelable direction is different from the expected traveling direction of the vehicle, speed-reduction assistance for reducing the speed of the vehicle or the informing assistance for prompting speed reduction of the vehicle is performed as the first assistance. When lighting of the arrow signal is recognized by the recognizing unit, and the travelable direction is not recognized, the second assistance having a smaller degree of assistance than the first assistance is performed until the travelable direction is recognized. Thus, since the driving assistance device can perform the second assistance before it performs the first assistance, the start of the assistance can be made earlier. Further, since the driving assistance device performs the second assistance having a smaller degree of assistance than the first assistance until the travelable direction is recognized, the occupant is less likely to be bothered as compared with the case where the first assistance is performed, even when the assistance turns out to be unnecessary.

In the driving assistance device of the above aspect, the assisting unit may be configured to reduce the speed of the vehicle at a first deceleration, as the first assistance, and reduce the speed of the vehicle at a second deceleration that is smaller than the first deceleration, as the second assistance. In this case, this device can make the occupant less likely to be bothered even when the speed-reduction assistance turns out to be unnecessary.

In the driving assistance device of the above aspect, the assisting unit may be configured to provide a speed-reduction display that prompts speed reduction of the vehicle with a first degree of emphasis, as the first assistance, and provide the speed-reduction display that prompts speed reduction of the vehicle with a second degree of emphasis which is smaller than the first degree of emphasis, as the second assistance. In the driving assistance device of the above aspect, the assisting unit may be configured to output sound that prompts speed reduction of the vehicle with a first degree of emphasis, as the first assistance, and output sound that prompts speed reduction of the vehicle with a second degree of emphasis which is smaller than the first degree of emphasis, as the second assistance. In these cases, this device can make the occupant less likely to be bothered even when the informing assistance turns out to be unnecessary.

In the driving assistance device as described above, the assisting unit may be configured to perform the first assistance without performing the second assistance, when lighting of the arrow signal is recognized by the recognizing unit, while the travelable direction of the arrow signal is not recognized by the recognizing unit, and a distance between the vehicle and the traffic light is equal to or smaller than a predetermined value. In this case, the second assistance having the smaller degree of assistance is prevented from being continued even when the distance between the vehicle and the traffic light becomes equal to or smaller than the threshold value.

In the driving assistance device as described above, the traffic light may be operable to further light a stop signal that directs all vehicles on a road on which the vehicle is traveling, not to travel past a stop position, and the arrow signal may be prioritized over the stop signal. The assisting unit may be configured to perform the first assistance when lighting of the stop signal is recognized by the recognizing unit, and the travelable direction of the arrow signal of which lighting is recognized by the recognizing unit is different from the expected traveling direction of the vehicle. When lighting of the stop signal and the arrow signal is recognized by the recognizing unit, and the travelable direction of the arrow signal is not recognized by the recognizing unit, the assisting unit may be configured to perform the second assistance until the travelable direction of the arrow signal is recognized by the recognizing unit. The assisting unit may be configured to perform the first assistance without performing the second assistance, when a deceleration needed for preventing the vehicle from traveling past the stop position is larger than a predetermined threshold value, at a time when lighting of the stop signal is recognized by the recognizing unit. In this case, the first assistance, rather than the second assistance, can be performed when the deceleration needed for preventing the vehicle from traveling past the stop position is larger than the predetermined threshold value.

According to the above aspect of the disclosure, the start of driving assistance based on the result of recognition of the traffic light operable to light the arrow signal can be made earlier, and the occupant is less likely to be bothered by the driving assistance.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of one example of a vehicle including a driving assistance device according to one embodiment;

FIG. 2A is a view showing one example of lightning patterns of a traffic light;

FIG. 2B is a view showing one example of lightning patterns of a traffic light;

FIG. 2C is a view showing one example of lightning patterns of a traffic light;

FIG. 2D is a view showing one example of lightning patterns of a traffic light;

FIG. 3 is a view illustrating one example of an intersection where the traffic light of FIG. 2A to FIG. 2D is used;

FIG. 4 is a flowchart illustrating one example of the operation of the driving assistance device;

FIG. 5A is a graph describing one example of speed-reduction assistance;

FIG. 5B is a graph describing one example of speed-reduction assistance;

FIG. 5C is a graph describing one example of speed-reduction assistance;

FIG. 6 is a view useful for describing a modified example of calculation of a second deceleration;

FIG. 7 is a flowchart illustrating a modified example of the operation of the driving assistance device;

FIG. 8A is a view showing another example of the traffic light;

FIG. 8B is a view showing another example of the traffic light;

FIG. 8C is a view showing another example of the traffic light; and

FIG. 8D is a view showing another example of the traffic light.

### DETAILED DESCRIPTION OF EMBODIMENTS

Exemplary embodiments will be described with reference to the drawings. In the following description, the same reference numerals or signs are assigned to the same or corresponding elements, of which description will not be repeated.

Configuration of Vehicle and Driving Assistance Device

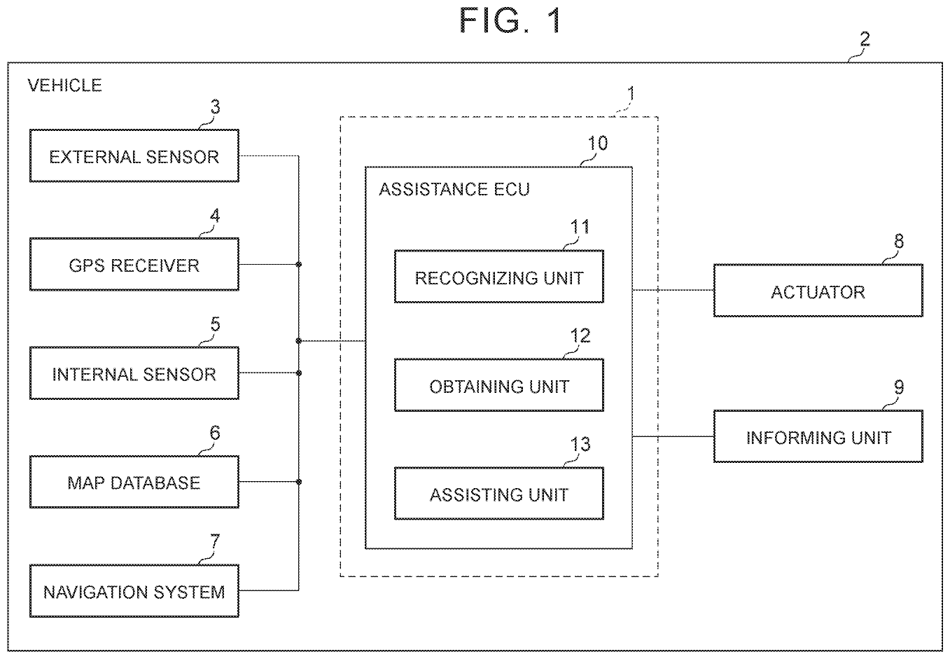

FIG. 1 is a functional block diagram showing one example of a vehicle 2 including a driving assistance device 1 according to one embodiment. As shown in FIG. 1, the driving assistance device 1 is installed in the vehicle 2, such as a passenger car, and assists in driving the vehicle 2 that travels toward a traffic light operable to light an arrow signal indicating a travelable direction in which the vehicle is allowed to travel. The arrow signal displays an arrow when it is lighted, and indicates the travelable direction with the shape of the arrow (the direction indicated by the arrow). The travelable direction is a direction in which the vehicle is allowed to travel. The traffic light will be described in detail later. The vehicle 2 includes an external sensor or sensors 3, GPS (global positioning system) receiver 4, internal sensors 5, map database 6, navigation system 7, actuators 8, informing unit 9, and assistance ECU (electronic control unit) 10.

The external sensor 3 is a detector that detects information on the external environment of the vehicle 2. The external environment means positions of objects around the vehicle 2, conditions of the objects, and so forth. Detection results of the external sensor 3 include positions, shapes, colors, etc. of objects in front of the vehicle 2 along a roadway on which the vehicle 2 travels. The objects include vehicles, pedestrians, traffic lights, road marking paints, and so forth. One example of the external sensor 3 is a camera.

The camera is an imaging instrument that images external conditions of the vehicle 2. The camera is provided on the rear side of the front windshield of the vehicle 2, for example. The camera obtains captured image information concerning external conditions of the vehicle 2. The camera may be a monocular camera or a stereo camera. The stereo camera has two imaging units located so as to reproduce binocular disparity. The captured image information of the stereo camera includes information of the depth direction.

The external sensor 3 is not limited to the camera, but may be a radar sensor. The radar sensor is a detector that detects objects around the vehicle 2, using radio waves (e.g., millimeter waves) or light. The radar sensor comprises, for example, a millimeter-wave radar, or LIDAR (Laser Imaging Detection and Ranging). The radar sensor detects an object by sending radio waves or light to the vicinity of the vehicle 2, and receiving the radio waves or light reflected by the object.

The GPS receiver 4 receives signals from three or more GPS satellites, and obtains position information indicating the position of the vehicle 2. The position information includes the latitude and longitude, for example. The GPS receiver 4 may be replaced with another means that can specify the latitude and longitude at which the vehicle 2 exists.

The internal sensors 5 are detectors that detect traveling conditions of the vehicle 2. The internal sensors 5 include a vehicle speed sensor, acceleration sensor, and yaw rate sensor. The vehicle speed sensor is a detector that detects the speed of the vehicle 2. As the vehicle speed sensor, a wheel speed sensor that is provided on a wheel of the vehicle 2 or on a driveshaft that rotates as a unit with the wheel, and detects the rotational speed of the wheel, is used, for example.

The acceleration sensor is a detector that detects the acceleration of the vehicle 2. The acceleration sensor may include a longitudinal acceleration sensor that detects the longitudinal acceleration of the vehicle 2, and a lateral acceleration sensor that detects the lateral acceleration of the vehicle 2. The yaw rate sensor is a detector that detects the yaw rate (rotational angular velocity) about the vertical axis passing the center of gravity of the vehicle 2. For example, a gyroscope sensor may be used as the yaw rate sensor.

The map database 6 is a storage unit that stores map information. The map database 6 is stored in an HDD (hard disk drive) installed in the vehicle 2, for example. The map database 6 contains, as map information, information on stationary objects, traffic rules, positions of traffic lights, and so forth. The stationary objects include, for example, road marking paints (including lane boundaries, such as white lines and yellow lines), and structural objects (such as curbs, poles, utility poles, buildings, marks or signs, and trees). A part of the map information included in the map database 6 may be stored in a storage device that is different from the HDD in which the map database 6 is stored. A part or the whole of the map information included in the map database 6 may be stored in a storage device other than storage devices included in the vehicle 2.

The navigation system 7 guides the driver of the vehicle 2 to a preset destination. The navigation system 7 recognizes a roadway and a lane on which the vehicle 2 is traveling, based on the position of the vehicle 2 measured by the GPS receiver 4, and the map information of the map database 6. The navigation system 7 computes a target route from the position of the vehicle 2 to the destination, and guides the driver through the target route, using HMI (Human Machine Interface).

The actuators 8 are devices that implement traveling control of the vehicle 2. The actuators 8 include at least an engine actuator, brake actuator, and steering actuator. The engine actuator changes the amount of air supplied to the engine (for example, changes the throttle opening), according to driving operation or a control signal of the assistance ECU 10 that will be described later, so as to control driving force of the vehicle 2. Where the vehicle 2 is a hybrid vehicle or electric vehicle, the engine actuator controls driving force of a motor as a power source.

The informing unit 9 is a device that presents information to occupants (including the driver) of the vehicle 2. The informing unit 9 comprises a display that displays the information, a speaker that outputs voice, or the like.

The assistance ECU 10 assists in driving the vehicle 2. The ECU is an electronic control unit having CPU (central processing unit), ROM (read-only memory), RAM (random access memory), CAN (Controller Area Network) communication circuit, and so forth. The assistance ECU 10 is connected to a network that communicates with the ECU 10 using the CAN communication circuit, for example, and is connected to the above constituent elements of the vehicle 2, such that the ECU 10 can communicate with the elements. The assistance ECU 10 inputs and outputs data by operating the CAN communication circuit, based on a signal generated by the CPU, for example, stores data in the RAM, loads a program stored in the ROM into the RAM, and executes the program loaded into the RAM, so as to implement the function of assistance. The assistance ECU 10 may consist of two or more electronic control units.

The assistance ECU 10 includes a recognizing unit 11, obtaining unit 12, and assisting unit 13. The recognizing unit 11 recognizes lighting of the arrow signal and the travelable direction, based on the detection result of the external sensor 3. As an example, the recognizing unit 11 recognizes lighting of the arrow signal and the travelable direction, by applying a pattern matching technology to pixel information.

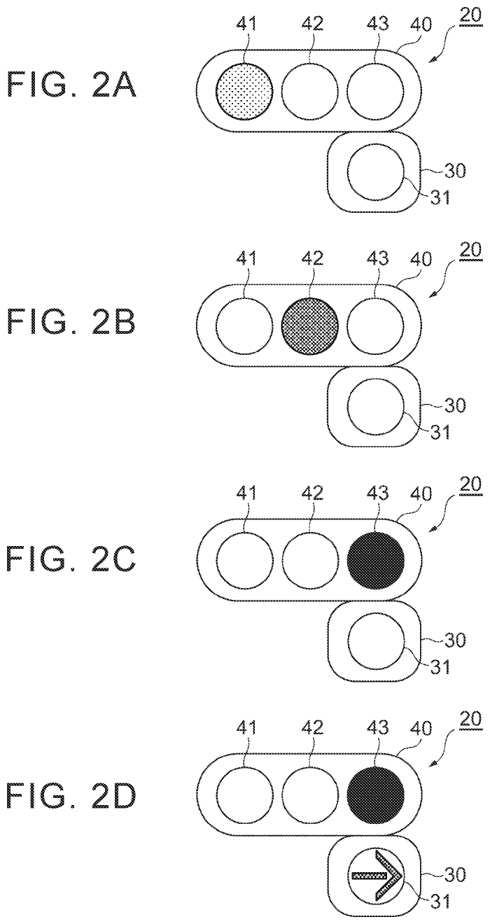

FIG. 2A to FIG. 2D show one example of lighting patterns of a traffic light 20. As shown in FIG. 2A to FIG. 2D, the traffic light 20 includes an arrow lamp device 30. The arrow lamp device 30 can switch an arrow signal 31 between an OFF state (FIG. 2A to FIG. 2C) in which the arrow signal 31 is not lighted, and an ON state (FIG. 2D) in which the arrow signal 31 is lighted. The traffic light 20 includes a lamp device 40 that lights a signal for giving directions to vehicles with a color, such as red, blue (or green), or yellow, for example, in addition to the arrow lamp device 30. In the example of FIG. 2A to FIG. 2D, the lamp device 40 displays a green signal 41, yellow signal 42, and red signal 43. The green signal 41 is a signal that permits the vehicle to proceed. The yellow signal 42 is a signal that inhibits the vehicle from proceeding past a stop position, except for the case where the vehicle cannot safely stop. The red signal 43 is a signal (one example of a stop signal) that inhibits the vehicle from proceeding past the stop position.

The traffic light 20 lights the green signal 41, yellow signal 42, and red signal 43, in the order of description. Any two of these signals are not lighted at the same time, and only one of the signals is lighted at a time. The traffic light 20 starts lighting the arrow signal 31 at the same time that the red signal 43 is lighted, or during lighting of the red signal 43. The arrow signal 31 is prioritized over the red signal 43. Namely, when the red signal 43 is lighted, the vehicle is allowed to proceed only in the direction indicated by the arrow signal 31, and is inhibited from proceeding in directions other than the direction indicated by the arrow signal 31, and from going beyond the stop position. The traffic light 20 finishes lighting the arrow signal 31 during lighting of the red signal 43. Then, when the traffic light 20 finishes lighting the red signal 43, it lights the green signal 41 again. Thus, the traffic light 20 repeatedly lights the green signal 41, yellow signal 42, and red signal 43 (red signal 43 and arrow signal 31) in this order.

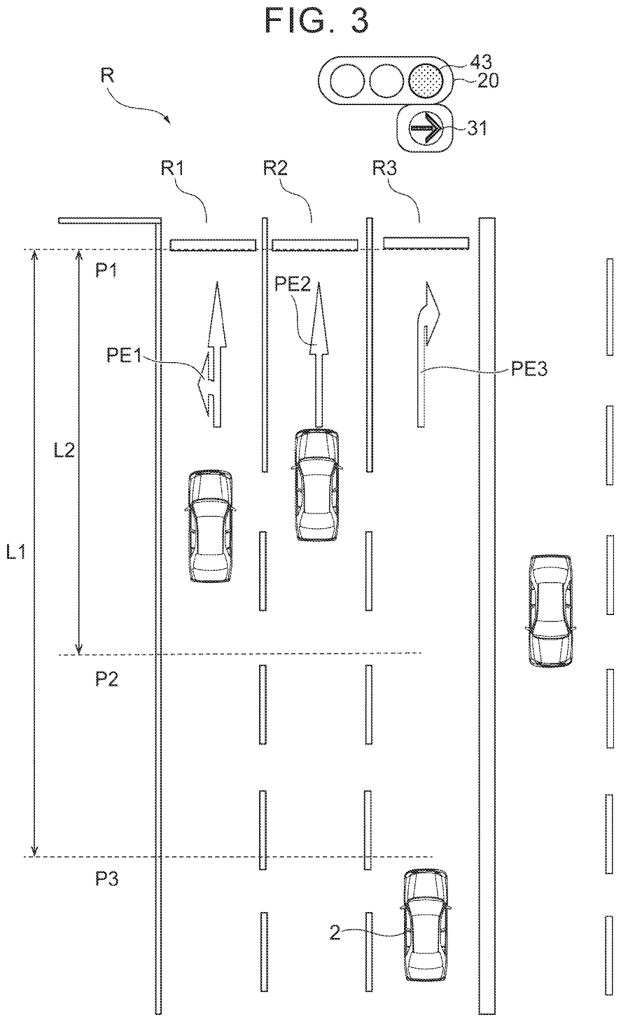

FIG. 3 is a view illustrating one example of an intersection where the traffic light of FIG. 2A to FIG. 2D is used. As shown in FIG. 3, the vehicle 2 travels on a road R that meets the intersection and has three lanes on each side. The road R includes a first lane R1, a second lane R2, and a third lane R3, arranged in this order as seen from the left side. The first lane, which allows vehicles to turn left or travel straight, is provided with a first road marking paint PE1 indicating that vehicles can turn left or travel straight. The second lane, which allows vehicles to travel straight, is provided with a second road marking paint PE2 indicating that vehicles can travel straight. The third lane, which allows vehicles to turn right, is provided with a third road marking paint PE3 indicating that vehicles can turn right. The traffic light 20 is installed in the intersection, so as to display a signal toward vehicles traveling on the road R.

The green signal 41, yellow signal 42, and red signal 43 of the traffic light 20 give directions to all vehicles traveling on the road R. When the green signal 41 of the traffic light 20 is lighted, all of the vehicles traveling on the road R are allowed to proceed. When the yellow signal 42 of the traffic light 20 is lighted, all of the vehicles traveling on the road R must not proceed past the position P1 (one example of the stop position), except for the case where they cannot safely stop at the position P1. When the red signal 43 of the traffic light 20 is lighted, all of the vehicles traveling on the road R must not proceed past the position P1.

The vehicle 2 travels while approaching the traffic light 20. The recognizing unit 11 of the vehicle 2 recognizes the traffic light 20 ahead of the vehicle 2. The recognizing unit 11 recognizes lighting of the arrow signal 31 and the travelable direction (the direction in which vehicles are allowed to travel). The arrow signal 31 has a meaning in its shape, and is less likely to be recognized due to the smaller display area as compared with color signals. Thus, as the vehicle 2 approaches the traffic light 20, the recognizing unit 11 initially recognizes lighting of the green signal 41, yellow signal 42, or red signal 43. At the same time that the color signal is recognized, or when the vehicle 2 gets further closer to the traffic light 20 (when the vehicle 2 reaches a position P3 apart from the traffic light 20 by a distance L1), the recognizing unit 11 recognizes lighting of the arrow signal 31. At the position P3, the recognizing unit 11 cannot recognize the travelable direction of the arrow signal 31. When the vehicle 2 gets further closer to the traffic light 20, from the position P3 at which lighting of the arrow signal 31 was recognized, i.e., when the vehicle 2 reaches a position P2 apart from the traffic light 20 by a distance L2, the recognizing unit 11 recognizes the travelable direction of the arrow signal 31.

Referring back to FIG. 1, the obtaining unit 12 obtains detection results of the internal sensors 5, namely, traveling conditions of the vehicle 2. The obtaining unit 12 obtains the current speed, acceleration, traveling position, etc. of the vehicle 2, for example.

The assisting unit 13 determines the content of driving assistance of the vehicle 2, and operates at least one of the actuators 8 and the informing unit 9, based on the traveling conditions of the vehicle 2 obtained by the obtaining unit 12 and the content of assistance. The driving assistance includes speed-reduction assistance and informing assistance. The speed-reduction assistance is to operate the actuator 8 according to the signal of the traffic light 20, so as to reduce the speed of the vehicle 2. The informing assistance is to operate the informing unit 9 according to the signal of the traffic light 20, so as to encourage the driver to reduce the speed of the vehicle 2 according to a lighting state of the traffic light. The informing assistance includes at least one of assistance that provides speed-reduction display for encouraging the driver to reduce the speed of the vehicle 2, and assistance that outputs sound for encouraging the driver to reduce the speed of the vehicle 2.

The assisting unit 13 determines an expected traveling direction of the vehicle 2, based on the detection result of the external sensor 3, so as to determine the content of driving assistance of the vehicle 2. The expected traveling direction is a direction in which the vehicle 2 is expected to proceed, in the intersection with the traffic light 20 as a control object ahead of the vehicle 2. The assisting unit 13 determines the direction in which the vehicle 2 is expected to proceed, based on a result of detection of a road marking paint on the lane in which the vehicle 2 is traveling. In the example of FIG. 3, the vehicle 2, which is traveling in the third lane R3, recognizes the third road marking paint PE3 of the third lane R3, and the assisting unit 13 determines the direction (right-turn) indicated by the third road marking paint PE3, as the expected traveling direction. The assisting unit 13 may also determine the expected traveling direction of the vehicle 2, based on the scheduled route of the navigation system 7. The assisting unit 13 may improve the reliability of the determination result, by checking the road marking paint against the scheduled route of the navigation system 7.

The assisting unit 13 starts driving assistance from the time when lighting of the arrow signal 31 is recognized (at the position P3). Namely, the assisting unit 13 starts driving assistance, in a condition where lighting of the arrow signal 31 is recognized, but the travelable direction is uncertain. In the example of FIG. 3, the arrow signal 31 is lighted when the red signal 43 is lighted. Accordingly, when lighting of the arrow signal 31 is recognized by the recognizing unit 11, the red signal 43 is also lighted. In this case, when the travelable direction of the arrow signal 31, which will be revealed later, matches the expected traveling direction of the vehicle 2, the vehicle 2 can proceed in the travelable direction of the arrow signal 31 even if the red signal 43 is lighted. When the travelable direction of the arrow signal 31, which will be revealed later, is different from the expected traveling direction of the vehicle 2, the vehicle 2 needs to follow the red signal 43. In this case, the vehicle 2 must not proceed past the position P1; therefore, the vehicle 2 needs to reduce its speed, so as not to proceed past the position P1. Namely, in the example of FIG. 3, two patterns, namely, a pattern in which the vehicle 2 proceeds in the travelable direction and a pattern in which the vehicle 2 reduces its speed, are considered as actions that can be taken when the travelable direction is revealed.

The assisting unit 13 starts at least one of the speed-reduction assistance and the informing assistance, assuming that the travelable direction of the arrow signal 31 is different from the expected traveling direction of the vehicle 2, though the travelable direction of the arrow signal 31 is still uncertain at the position P3. Thus, the speed-reduction assistance and informing assistance started in advance on the assumption of speed reduction in the future will be called “second assistance”. The assisting unit 13 starts the second assistance, from the time when the vehicle is located at the position P3, and continues it until the vehicle 2 reaches the position P2. Namely, the assisting unit 13 starts the second assistance from the time of lighting of the arrow signal 31, and performs the second assistance until the travelable direction of the arrow signal 31 is recognized by the recognizing unit 11.

When the vehicle 2 reaches the position P2, and the travelable direction of the arrow signal 31 is recognized by the recognizing unit 11, the assisting unit 13 determines whether the travelable direction of the arrow signal 31 matches the expected traveling direction of the vehicle 2. When the travelable direction of the arrow signal 31 matches the expected traveling direction of the vehicle 2, the assisting unit 13 does not perform driving assistance since the vehicle is allowed to proceed. When the travelable direction of the arrow signal 31 is different from the expected traveling direction of the vehicle 2, the assisting unit 13 performs driving assistance including at least one of the speed-reduction assistance and the informing assistance. Thus, the speed-reduction assistance performed based on the travelable direction detected by the external sensor 3 will be called “first assistance”.

The first assistance and the second assistance are different in the degree of assistance. The degree of assistance is a measure of the magnitude or amount of assistance. The amount of assistance increases as the degree of assistance increases. The second assistance provides a smaller degree of assistance than the first assistance. Where the first assistance and the second assistance are speed-reduction assistance, for example, the assisting unit 13 reduces the speed of the vehicle 2 at a first deceleration, as the first assistance, and reduces the speed of the vehicle 2 at a second deceleration that is smaller than the first deceleration, as the second assistance. As an example, the assisting unit 13 calculates a deceleration that prevents the vehicle 2 from proceeding past the position P1, using the distance between the traveling position of the vehicle 2 and the traffic light 20 (or the position P1), and the current vehicle speed. As a more specific example, the assisting unit 13 calculates a deceleration that causes the vehicle 2 to stop at the position P, and sets the calculated deceleration as the first deceleration. Then, the assisting unit 13 calculates the second deceleration, by multiplying the first deceleration by a predetermined coefficient (smaller than 1).

When the first assistance and the second assistance are informing assistance, for example, the assisting unit 13 displays a speed-reduction indication that prompts speed reduction of the vehicle 2, with a first degree of emphasis, as the first assistance, and displays a speed-reduction indication that prompts speed reduction of the vehicle 2, with a second degree of emphasis that is smaller than the first degree of emphasis, as the second assistance. The degree of emphasis in display is a measure of the intensity of informing operation via display. The degree of emphasis in display increases as the brightness, color saturation, lightness, or the like, is greater. The degree of emphasis in display may be smaller as the degree of transparency is higher.

When the first assistance and the second assistance are informing assistance, for example, the assisting unit 13 may output sound that prompts speed reduction of the vehicle 2 with a first degree of emphasis, as the first assistance, and output sound that prompts speed reduction of the vehicle 2 with a second degree of emphasis that is smaller than the first degree of emphasis, as the second assistance. The degree of emphasis in sound is a measure of the intensity of informing operation via sound. The degree of emphasis in sound increases as the volume is larger or the pitch is higher. The degree of emphasis in sound may increase as the rhythm is faster. Also, in the second assistance, the degree of emphasis in sound may be reduced by delaying the informing timing as compared with that of the first assistance.

Operation of Driving Assistance Device

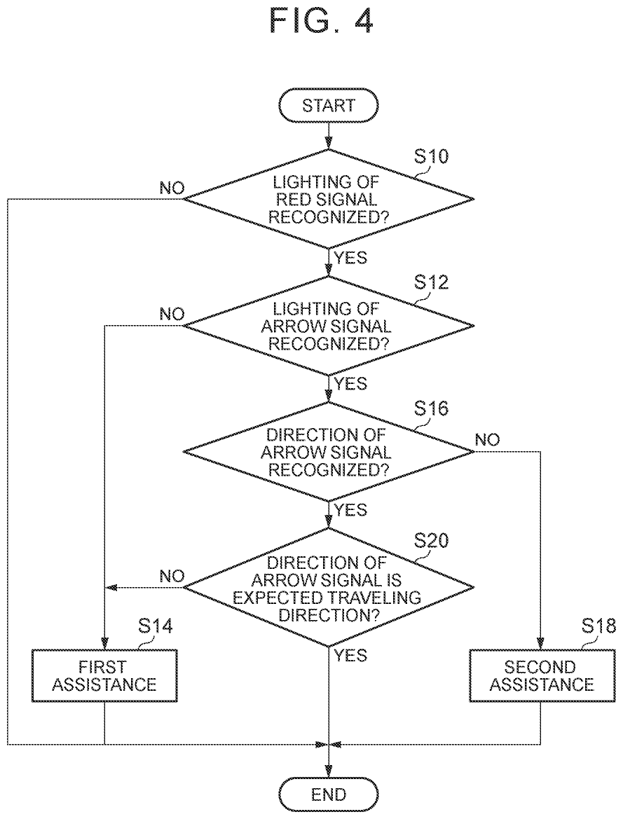

FIG. 4 is a flowchart illustrating one example of the operation of the driving assistance device. A routine shown in the flowchart of FIG. 4 is executed by the assistance ECU 10 of the driving assistance device 1. The assistance ECU 10 starts the routine when an assistance start button is turned ON, through operation of a vehicle occupant, for example. While the case where the driving assistance is the speed-reduction assistance will be described by way of example, the routine of the same flowchart would be executed when the driving assistance is the informing assistance.

As shown in FIG. 4, the assisting unit 13 of the assistance ECU 10 determines whether the red signal 43 is recognized by the recognizing unit 11, based on the detection result of the external sensor 3, in a red-signal recognizing step (S10).

When lighting of the red signal 43 is not recognized by the recognizing unit 11 (S10: NO), the current cycle of the routine shown in the flowchart of FIG. 4 ends. After the end of each cycle of the routine, the routine is started again from the initial step, until an end-of-assistance condition is satisfied. The end-of-assistance condition is, for example, that an assistance end button is turned ON. Thus, the routine in the flowchart of FIG. 4 is repeatedly executed, until lighting of the red signal 43 is recognized by the recognizing unit 11.

When it is determined that lighting of the red signal 43 is recognized by the recognizing unit 11 (S10: YES), the assisting unit 13 determines whether lighting of the arrow signal 31 is recognized by the recognizing unit 11, based on the detection result of the external sensor 3, in a lighting recognizing step (S12).

When it is determined that lighting of the arrow signal 31 is not recognized by the recognizing unit 11 (S12: NO), the assisting unit 13 performs the first assistance in a first assisting step (S14). In this case, the vehicle 2 follows the red signal 43. The assisting unit 13 calculates the first deceleration, based on the distance to the traffic light 20 and the current vehicle speed, for example, and starts reducing the speed of the vehicle 2 at the first deceleration, so as to prevent the vehicle 2 from proceeding past the position P1.

After the first assisting step (S14) is finished, the current cycle of the routine shown in the flowchart of FIG. 4 ends. After the end of each cycle, the routine is started again from the initial step, until the end-of-assistance condition is satisfied. Thus, the routine shown in the flowchart of FIG. 4 is repeated; when the arrow signal 31 is kept not being lighted during lighting of the red signal 43, the first assistance continues to be performed while the first deceleration is adjusted, and the vehicle 2 is decelerated so as not to go beyond the position P1, and is ultimately stopped.

Here, when it is determined that lighting of the arrow signal 31 is recognized by the recognizing unit 11 (S12: YES), the assisting unit 13 determines, in a direction recognizing step (S16), whether the direction of the arrow signal 31 is recognized by the recognizing unit 11.

When it is determined that the direction of the arrow signal 31 is recognized by the recognizing unit 11 (S16: YES), the assisting unit 13 determines whether the direction of the arrow signal 31 is the expected traveling direction, in a direction determining step (S20).

When it is determined that the direction of the arrow signal 31 is the expected traveling direction (S20: YES), the vehicle 2 is allowed to proceed; therefore, the assisting unit 13 finishes the routine shown in the flowchart of FIG. 4, without performing driving assistance. When it is determined that the direction of the arrow signal 31 is not the expected traveling direction (S20: NO), the assisting unit 13 executes the first assisting step (S14), and finishes the current cycle of the routine shown in the flowchart of FIG. 4. After the end of the cycle, the routine is started again from the initial step, until the end-of-assistance condition is satisfied. Thus, the vehicle 2 takes either of the actions as follows: (1) proceeding according to the arrow signal 31, and (2) decelerating according to the red signal 43 with the first assistance, since the direction of the arrow signal 31 is not the expected traveling direction.

When it is determined that the direction of the arrow signal 31 is not recognized by the recognizing unit 11 (S16: NO), the assisting unit 13 performs the second assistance with a smaller degree of assistance than the first assistance, in a second assisting step (S18). The assisting unit 13 reduces the speed of the vehicle 2 at a second deceleration that is smaller than the first deceleration. When the second assisting step (S18) ends, the current cycle of the routine shown in the flowchart of FIG. 4 ends. After the end of the cycle, the routine is started again from the initial step, until the end-of-assistance condition is satisfied. Thus, the routine shown in the flowchart of FIG. 4 is repeated, and the second assistance continues to be performed, until the direction of the arrow signal 31 is recognized.

One Example of Speed-Reduction Assistance

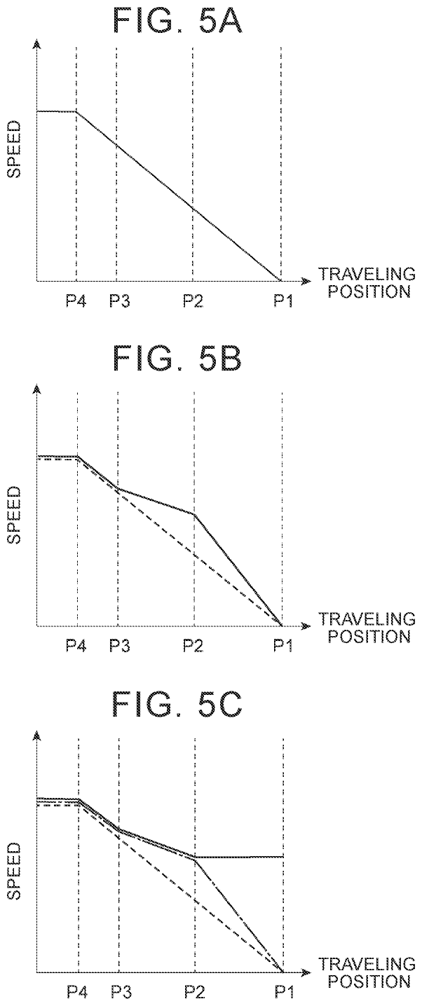

The routine shown in the flowchart of FIG. 4 is executed, so that the speed-reduction assistance shown in FIG. 5A to FIG. 5C is realized. FIG. 5A to FIG. 5C are graphs describing one example of the speed-reduction assistance. In FIG. 5A to FIG. 5C, the horizontal axis indicates the traveling position, and the vertical axis indicates the speed. The position P1 is the stop position, and the position P4 is a position at which the red signal 43 can be recognized, while the position P3 is a position at which lighting of the arrow signal 31 can be recognized, and the position P2 is a position at which the direction of the arrow signal 31 can be recognized.

The graph shown in FIG. 5A shows one example of the speed-reduction assistance performed when only the red signal 43 is lighted. The driving assistance device 1 recognizes the red signal 43 at the position P4, and starts the first assistance. With the first assistance, the speed of the vehicle 2 is reduced. Since the driving assistance device 1 does not recognize lighting of the arrow signal 31 at the position P3, it continues the first assistance after the vehicle 2 reaches the position P3, and the speed of the vehicle 2 is reduced until the vehicle 2 reaches the position P1.

The graph shown in FIG. 5B shows one example of the speed-reduction assistance performed when the red signal 43 and the arrow signal 31 are lighted. In FIG. 5B, the broken line indicates the graph of FIG. 5A. The driving assistance device 1 recognizes the red signal 43 at the position P4, and starts the first assistance. With the first assistance, the speed of the vehicle 2 is reduced. Then, the driving assistance device 1 recognizes lighting of the arrow signal 31 at the position P3. Since the direction of the arrow signal 31 is uncertain, the driving assistance device 1 performs the second assistance. With the second assistance, the speed of the vehicle 2 is reduced at a relatively small rate. Then, the driving assistance device 1 recognizes the direction of the arrow signal 31 at the position P2. In the example of FIG. 5B, the direction of the arrow signal 31 is different from the expected traveling direction. Therefore, the driving assistance device 1 reduces the speed of the vehicle 2 from the position P2, so as to prevent the vehicle 2 from proceeding past the position P1.

The graph shown in FIG. 5C shows one example of the speed-reduction assistance performed when the red signal 43 and the arrow signal 31 are lighted. In FIG. 5C, the broken line indicates the graph of FIG. 5A, and the one-dot chain line indicates the graph of FIG. 5B. The driving assistance device 1 recognizes the red signal 43 at the position P4, and starts the first assistance. With the first assistance, the speed of the vehicle 2 is reduced. Then, the driving assistance device 1 recognizes lighting of the arrow signal 31 at the position P3. Since the direction of the arrow signal 31 is uncertain, the driving assistance device 1 performs the second assistance. With the second assistance, the speed of the vehicle 2 is reduced at a relatively small rate. Then, the driving assistance device 1 recognizes the direction of the arrow signal 31 at the position P2. In the example of FIG. 5C, the direction of the arrow signal 31 matches the expected traveling direction. Thus, the driving assistance device 1 does not reduce the speed of the vehicle 2 from the position P2, but makes the speed constant.

In FIG. 5A to FIG. 5C, the position P4 and the position P3 may be the same position. In this case, space between the position P4 and the position P3 is eliminated in the graphs of the speed.

### Summary of Embodiment

In the driving assistance device 1, when lighting of the arrow signal 31 is recognized by the recognizing unit 11, and the travelable direction indicated by the arrow signal 31 is different from the expected traveling direction of the vehicle 2, the speed-reduction assistance to reduce the speed of the vehicle 2 or the informing assistance to prompt speed reduction of the vehicle 2 is performed as the first assistance. When lighting of the arrow signal 31 is recognized by the recognizing unit 11, and the travelable direction is not recognized, the second assistance having the smaller degree of assistance than the first assistance is performed until the travelable direction is recognized. Thus, since the driving assistance device 1 can perform the second assistance before the first assistance is performed, the assistance can be started at an earlier point in time. Further, the driving assistance device 1 performs the second assistance having the smaller degree of assistance than the first assistance until the travelable direction is recognized; thus, even when the second assistance turns out to be unnecessary assistance, the occupant is less likely to be bothered, as compared with the case where the first assistance is performed.

While the exemplary embodiment has been described above, the disclosure is not limited to the exemplary embodiment, but the embodiment may be subjected to various omissions, replacements, and changes.

Modified Example of Deceleration of Second Assistance

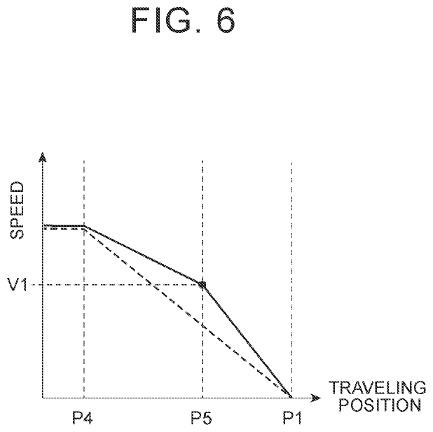

The second deceleration as the deceleration of the second assistance is not limited to that calculated by multiplying the first deceleration by the predetermined coefficient. FIG. 6 is a graph useful for describing a modified example of calculation of the second deceleration. In the graph shown in FIG. 6, the horizontal axis indicates the traveling position, and the vertical axis indicates the speed. In FIG. 6, the broken line indicates the result of the first assistance, and the solid line indicates the result of the first assistance and the second assistance. Position P1 is a stop position, and position P4 is a position at which lighting of the red signal 43 and the arrow signal 31 can be recognized, while position P5 is a position measured in advance, at which the direction of the arrow signal 31 can be recognized. Thus, the second assistance is performed between the position P4 and the position P5. The upper-limit speed V1 that must be achieved at the position P5, when the vehicle 2 is decelerated at the maximum speed from the position P5 and stops at the position P1, is calculated. The assisting unit 13 calculates the deceleration from the position P4, so as to achieve the upper-limit speed V1 at the position P5. The deceleration may be corrected in view of variations in the distance between the traffic light 20 and the position P1. Thus, by using the maximum speed, it is possible to avoid a situation where the deceleration of the second assistance is limited to an extent greater than necessary, resulting in a lack of time for speed reduction.

Modified Example of Operation of Driving Assistance Device

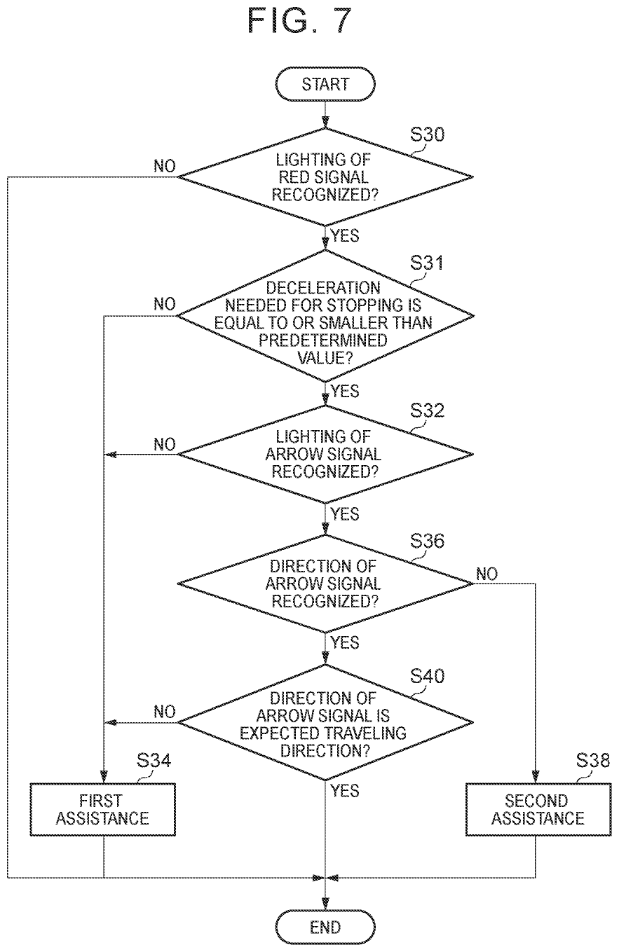

FIG. 7 is a flowchart illustrating a modified example of the operation of the driving assistance device. The flowchart shown in FIG. 7 is identical with the flowchart shown in FIG. 4, except that the routine of the flowchart of FIG. 7 includes a step of determining whether the deceleration is equal to or smaller than a predetermined value.

A red-signal recognizing step (S30) shown in FIG. 7 is the same as the red-signal recognizing step (S10) shown in FIG. 4.

When it is determined that lighting of the red signal 43 is recognized by the recognizing unit 11 (S30: YES), the assisting unit 13 calculates a deceleration needed for stopping the vehicle, in a deceleration determining step (S31). Then, the assisting unit 13 determines whether the deceleration needed for stopping the vehicle is equal to or smaller than a predetermined value (equal to or smaller than a predetermined threshold value). When the deceleration needed for stopping the vehicle is equal to or smaller than the predetermined value, the following steps (S32) to (S40) are executed in the same manners as steps (S12) to (S20) in FIG. 4. Steps (S32) to (S40) in FIG. 7 are identical with steps (S12) to (S20) of FIG. 4. With the routine shown in the flowchart of FIG. 7 thus executed, the assisting unit 13 can perform the first assistance without performing the second assistance, when the deceleration needed for preventing the vehicle to travel past the stop position is not equal to nor smaller than (i.e., is larger than) the predetermined threshold value.

The assisting unit 13 may be configured to perform the first assistance without performing the second assistance, when lighting of the arrow signal 31 is recognized by the recognizing unit 11, while the travelable direction of the arrow signal 31 is not recognized by the recognizing unit 11, and the distance between the vehicle 2 and the traffic light 20 becomes equal to or smaller than a threshold value. In this case, it is possible to avoid a situation where a necessary stop distance cannot be ensured because of execution of the second assistance.

Modified Examples of Traffic Light

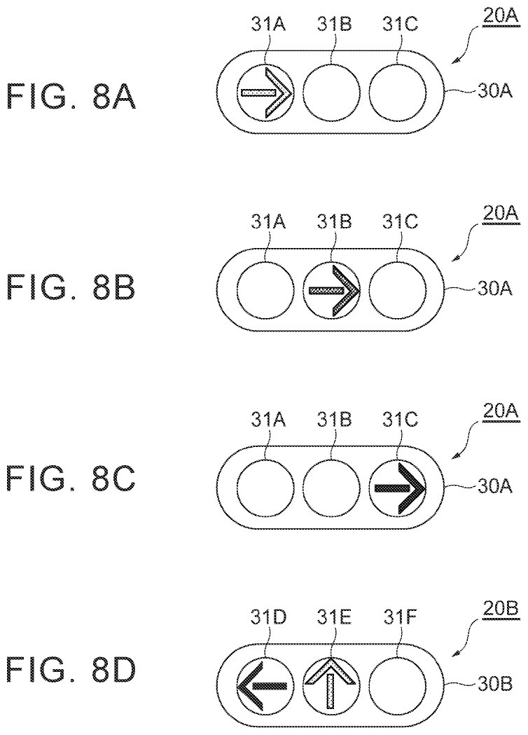

This disclosure is not limited to the traffic light 20 shown in FIG. 2A to FIG. 2D. FIG. 8A to FIG. 8D show other examples of traffic lights. As shown in FIG. 8A to FIG. 8D, a traffic light 20A includes an arrow lamp device 30A. The arrow lamp device 30A displays a green arrow signal 31A, yellow arrow signal 31B, and red arrow signal 31C, in the order of description. The meaning of each color of the arrow signal is the same as that of each color of the signal in the traffic light of the illustrated embodiment, and the vehicle is allowed to proceed in the arrow direction, only when the green arrow signal 31A is lighted. Thus, the traffic light may be able to display only the arrow signals. Also, as shown in FIG. 8D, a traffic light 20B includes an arrow lamp device 30B. The arrow lamp device 30B includes arrow signals 31D to 31F that can be lighted for respective travelable directions. Thus, the traffic light may be configured to light the arrow signals 31D to 31F prepared for respective traveling directions. Also, the location where the traffic light is installed is not limited to the road as shown in FIG. 3, but the traffic light may be installed on a two-lane road with one lane on each side, four-lane road with two lanes on each side, and a road having four or more lanes on each side.

What is claimed is:

1. A driving assistance device that assists in driving a vehicle that travels toward a traffic light operable to light an arrow signal indicating a travelable direction, comprising:
a recognizing unit configured to recognize lighting of the arrow signal and the travelable direction, based on a detection result of an external sensor that detects information on an external environment of the vehicle; and
an assisting unit configured to perform first assistance including at least one of speed-reduction assistance for reducing a speed of the vehicle and informing assistance for prompting speed reduction of the vehicle, when the travelable direction of the arrow signal of which lighting is recognized by the recognizing unit is different from an expected traveling direction of the vehicle, wherein
when lighting of the arrow signal is recognized by the recognizing unit, and the travelable direction of the arrow signal is not recognized by the recognizing unit, the assisting unit is configured to perform second assistance having a smaller degree of assistance than the first assistance, until the travelable direction of the arrow signal is recognized by the recognizing unit.

2. The driving assistance device according to claim 1, wherein the assisting unit is configured to reduce the speed of the vehicle at a first deceleration, as the first assistance, and reduce the speed of the vehicle at a second deceleration that is smaller than the first deceleration, as the second assistance.

3. The driving assistance device according to claim 1, wherein the assisting unit is configured to provide a speed-reduction display that prompts speed reduction of the vehicle with a first degree of emphasis, as the first assistance, and provide the speed-reduction display that prompts speed reduction of the vehicle with a second degree of emphasis which is smaller than the first degree of emphasis, as the second assistance.

4. The driving assistance device according to claim 1, wherein the assisting unit is configured to output sound that prompts speed reduction of the vehicle with a first degree of emphasis, as the first assistance, and output sound that prompts speed reduction of the vehicle with a second degree of emphasis which is smaller than the first degree of emphasis, as the second assistance.

5. The driving assistance device according to claim 1, wherein the assisting unit is configured to perform the first assistance without performing the second assistance, when lighting of the arrow signal is recognized by the recognizing unit, while the travelable direction of the arrow signal is not recognized by the recognizing unit, and a distance between the vehicle and the traffic light is equal to or smaller than a predetermined value.

6. The driving assistance device according to claim 2, wherein:
the traffic light is operable to further light a stop signal that directs all vehicles on a road on which the vehicle is traveling, not to travel past a stop position;
the arrow signal is prioritized over the stop signal;
the assisting unit is configured to perform the first assistance when lighting of the stop signal is recognized by the recognizing unit, and the travelable direction of the arrow signal of which lighting is recognized by the recognizing unit is different from the expected traveling direction of the vehicle;
when lighting of the stop signal and the arrow signal is recognized by the recognizing unit, and the travelable direction of the arrow signal is not recognized by the recognizing unit, the assisting unit is configured to perform the second assistance until the travelable direction of the arrow signal is recognized by the recognizing unit; and
the assisting unit is configured to perform the first assistance without performing the second assistance, when a deceleration needed for preventing the vehicle from traveling past the stop position is larger than a predetermined threshold value, at a time when lighting of the stop signal is recognized by the recognizing unit.
